(19) United States
(12) Patent Application Publication
(10) Pub. No.: US 2016/0232130 A1
(43) Pub. Date: Aug. 11, 2016

(54) MOBILE WEB APPLICATION FRAMEWORK

(71) Applicant: Syntel, Inc., Troy, MI (US)

(72) Inventors: Dheeraj Patankar, Erandwane (IN); Anirudha Rajendra Dhaneshwar, Kothrud (IN)

(73) Assignee: Syntel, Inc., Troy, MI (US)

(21) Appl. No.: 14/614,971

(22) Filed: Feb. 5, 2015

(51) Int. Cl. G06F 17/21; G06F 17/22

(52) U.S. Cl. CPC G06F 17/211; G06F 17/2264

(57) ABSTRACT

Pages of a mobile web application may be configured and provided through the web application in conjunction with middleware. The middleware may provide a configuration page for an administrator to add, remove, and edit configurations of a static number of pages in the application. The content of a page (e.g., content artifacts) may be determined at the time the page is requested by a mobile device by retrieving the configuration associated with the device or user requesting the page. A system implementing the middleware may include a redirection module that provides the requested mobile page to a requesting mobile device, and the configuration page to a requesting non-mobile device.

### BACKGROUND

a. Technical Field

The present disclosure relates to business software, including mobile web-enabled business software.

b. Background Art

This background description is set forth below for the purpose of providing context only. Therefore, any aspects of this background description, to the extent that it does not otherwise qualify as prior art, is neither expressly nor impliedly admitted as prior art against the instant disclosure.

Web-enabled business collaboration software is becoming increasingly important as more and more businesses and employees perform an increasing number of their business activities online. With a workforce that has consistent network access, businesses can implement collaboration software to allow employees to easily share files, share calendars, discuss the activities of the business, and so on. For example, many businesses provide their employees and clients with collaboration capabilities through Microsoft™ SharePoint™ Microsoft Dynamics™ CRM, Microsoft Dynamics™ AX, and the like. In addition, with the increased use of smartphones, tablets, and other mobile devices for business purposes, many businesses are enabling their collaboration software for mobile use.

As the ability to provide employees and clients collaborative capabilities has increased, so has the need to ensure that the proper users of the collaboration application have access to the proper information. Security concerns, information that may not be relevant to all employees working on a collaborative business application, and other concerns may drive a need to limit the information available to any given user of the application to less than all of the available information. For example, an engineer may not need the same documents and calendar information as a marketing professional, and a sales professional may not be permitted to access the same files and discussions as another sales professional working on different sales accounts.

Known business collaboration applications do not allow for customization of content in the application for different employees as efficiently or simply as possible, especially for mobile applications. There is, therefore, a need for solutions that improve the ease of providing mobile web applications for business and other purposes, as well as the robustness of the pages of the mobile web application itself. The foregoing discussion is intended only to illustrate the present field and should not be taken as a disavowal of claim scope.

### SUMMARY

In an embodiment, a method of providing a mobile web application may include receiving a request for a web page, the request originating from a mobile device and selecting, responsive to the request, one or more content artifacts to be rendered from a plurality of content artifacts. The method may further include retrieving the one or more content artifacts from a content database, defining code that describes how the one or more content artifacts should be formatted on the mobile device, and transmitting the one or more content artifacts and the code for the mobile device. The method may be embodied as code on a non-transitory computer-readable medium.

In an embodiment, a method of configuring and providing a mobile web application may include receiving a first request for a mobile web page, the first request originating at a non-mobile device and causing, responsive to the first request, a configuration web page allowing configuration of the mobile web page to be transmitted to the non-mobile device. The method may further include receiving a second request for the mobile web page, the second request originating at a mobile device, selecting, responsive to the second request, one or more content artifacts to be rendered from a plurality of content artifacts, and causing a mobile web page comprising the one or more content artifacts to be transmitted to the mobile device. The method may be embodied as code on a non-transitory computer-readable medium.

An exemplary embodiment of a system for configuring and providing a mobile web application may include a data server storing a plurality of content artifacts, a web application configured to provide a static number of web pages for rendering on mobile devices, and middleware. The middleware may be configured to receive a request for one of the web pages, the request originating from a mobile device, select a stored configuration associated with a user of the mobile device, wherein the configuration is retrieved from a plurality of stored configurations respectively associated with different users, each configuration including a set of content artifacts, retrieve content artifacts from the database according to the selected configuration, and provide the retrieved content artifacts to the web application for transmission to the mobile device on a web page. The middleware and web application may be embodied as code on a non-transitory computer-readable medium. The middleware and/or web application may be deployed on a web server, in an embodiment.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is a block diagram view of an exemplary embodiment of a system for providing a mobile web application.

FIG. 2 is a block diagram view of an exemplary embodiment of a system for providing a mobile web application.

FIG. 3 is an alternate block diagram view of a portion of the system of FIG. 2.

FIG. 4 is a flow chart illustrating an exemplary embodiment of a method of configuring and providing a mobile web page.

### DETAILED DESCRIPTION

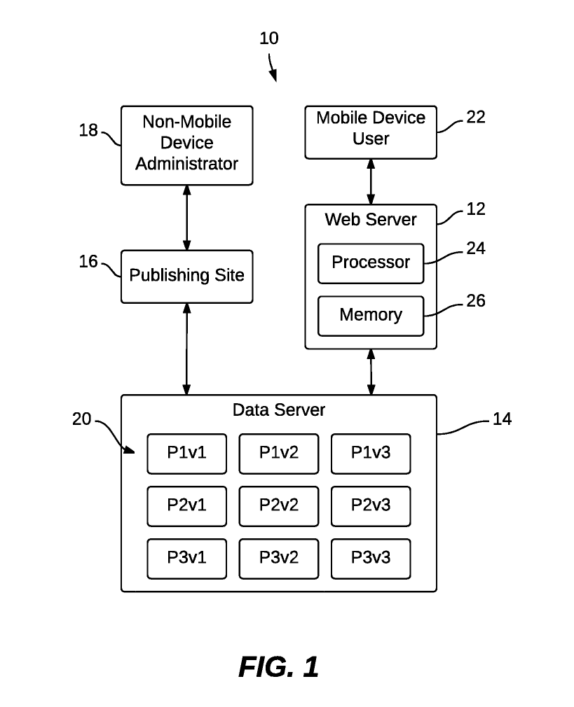

Referring to the drawings, wherein like reference numerals indicate the same or similar components in the various views, FIG. 1 is a block diagram view of an exemplary embodiment of a system 10 for providing a mobile web application. The system 10 may include a web server 12, a data server 14, and a publishing site 16. The mobile web application may comprise one or more web pages intended for access on mobile devices, in an embodiment.

The instant disclosure discusses “mobile devices” in numerous respects. As used herein, a “mobile device” refers to a computing apparatus such as a cell phone, tablet, PDA, and the like, or another computing device utilizing a mobile web browser and configured to access one or more web pages provided by the web server through a mobile browser. In contrast, a “non-mobile device” refers to a desktop or laptop computing device, other another computing device utilizing a full-featured, non-mobile browser.

In an embodiment, the mobile web application may be server-client application, such as a Microsoft™ SharePoint™ application, or other web-based application such as Microsoft Dynamics™ CRM, Microsoft Dynamics™ AX, and the like. Of course, these are merely examples, and the instant disclosure is not limited to any of these applications unless explicitly set forth in the claims. For ease of description, the instant disclosure will refer to a Microsoft™ SharePoint™ application, but it should be understood that this description is exemplary in nature only.

The publishing site 16 may receive input from a non-mobile device of an administrator 18 of the mobile web application for defining versions of pages within the web application. Accordingly, with the publishing site 16, the administrator may add, remove, and revise different versions of different web pages. Through the publishing site 16, the administrator may further make a particular version of a particular mobile web page “live” for access by users. The publishing site 16 may be deployed on the web server 12, in an embodiment, but is shown separately for ease of illustration.

The data server 14 may comprise one or more databases and hardware and software for managing those databases, in an embodiment, and may be configured to store, retrieve, and transmit the various versions of the various mobile web pages of the mobile web application. That is, for example, and as illustrated in FIG. 1, the data server may store a plurality of versions of each of a plurality of pages 20 (three pages P1, P2, P3 are illustrated in FIG. 1, each with three versions v1, v2, v3).

The data server 14 may further store a plurality of content artifacts (not shown in FIG. 1). In an embodiment, such artifacts may include components included on SharePoint™ Lists, Documents, Discussions, Calendars, Tasks, etc. The content artifacts may be provided by the data server for the web application to provide on the web page versions stored on the data server.

The web server 12 may be configured to accept a mobile web page request from a user mobile device 22, to retrieve the requested page from the data server 14, and to return the requested page to the user's mobile device 22. As part of the page request, the web server 12 may receive information regarding the user or mobile device 22 itself. The web server 12 may request the page version appropriate for the user or mobile device from the data server (that is, the version of the page defined as “live” for the user or mobile device by the administrator), and return that version to the user's mobile device. For example, if the publishing site has defined version three (v3) of each of the pages (P1, P2, P3), the web server may retrieve version three (v3) of the requested page to the mobile device 22.

The web server 12 may include an electronic processor 24 and a non-transitory computer-readable memory 26, implemented as an article of manufacture. The processor 24 may be configured generally to control the overall operation of the web server 12, which may include controlling the memory 26. In embodiments, the processor 24 may include one or more programmable processors, microprocessors, and/or microcontrollers. In addition, the processor may include a central processing unit (CPU), memory (in addition to or such as the illustrated memory 26) and an input/output (I/O) interface through which the processor may receive a plurality of input signals. Such an I/O interface may also be configured to generate a plurality of output signals.

The web server 12 and data server 14 may each be connected to one or more networks by way of respective network interfaces. Such networks may include, for example, an intranet (e.g., a LAN), the internet, a cellular network, and/or other networks. The respective network interfaces may permit services or programs such as, but not limited to, a mobile web application as illustrated and/or described herein, of the web server 12 and data server 14 to be provided in a client-server model.

The memory 26 may be provided for storage of data, instructions, and/or code and is electrically coupled to at least the processor 24. The memory 26 may include various forms of non-transitory non-volatile memory including flash memory, read only memory (ROM) including various forms of programmable read only memory (e.g., PROM, EPROM, EEPROM) and/or volatile memory including random access memory (RAM) including static random access memory (SRAM), dynamic random access memory (DRAM) and synchronous dynamic random access memory (SDRAM). Although illustrated as a separate component in the illustrated embodiment, it should be understood that the memory 26 may be internal to the processor 24, in an embodiment.

The system 10 of FIG. 1 includes a plurality of different versions of the pages of the mobile application (i.e., P1v1, P2v1, P3v1, P1y2, P2v2, P3v2, P1y3, P2v3, P3v3) with different pages potentially including different content for different device types and/or for different users. To allow for access to different information by different users or different devices, then, the administrator creates as many different page versions as there are different combinations of information to be made available.

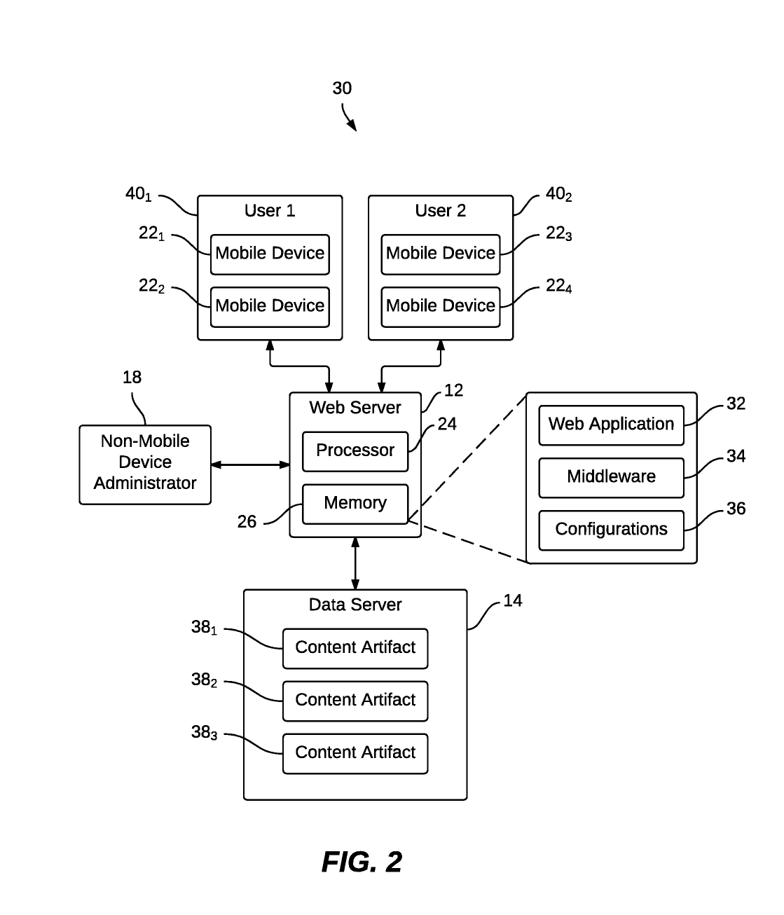

FIG. 2 is a block diagram view of a second embodiment of a system 30 for providing a mobile web application. The system 30 may include a web server 12 and a data server 14. In the second system 30, unlike the first system 10, a publishing site may be unnecessary, as will be explained below.

The data server 14 and web server 12 of the second system 30 may include the same physical components as in the first system 10, in an embodiment. But, in the second system 30, the software provided in the web server 12 and/or data server 14 may enable different processes and capabilities than were set forth for the first system 10.

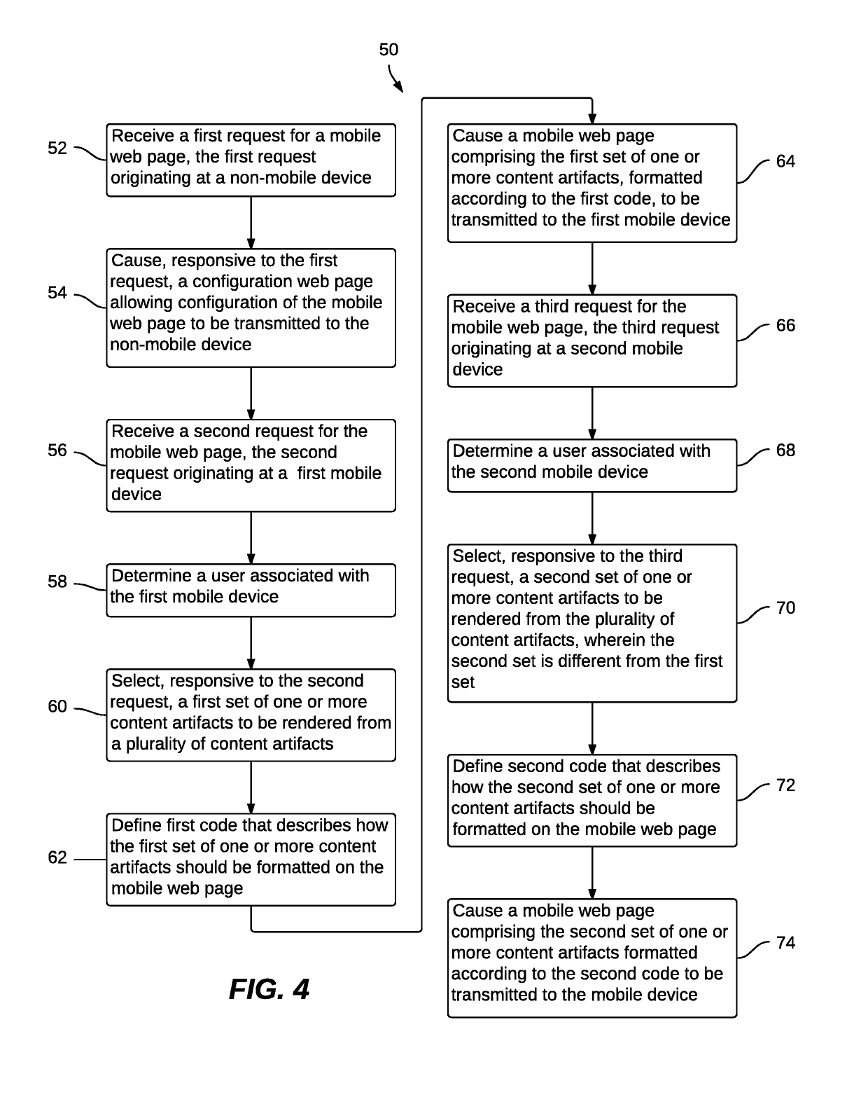

With continued reference to FIG. 2, the web server 12 may be configured to perform one or more tasks, steps, and/or methods described in this disclosure. For example, in an embodiment, tasks, steps, and/or methods described in this disclosure may be stored in the memory 26 in the form of instructions that, when executed by the processor 24, cause the processor to perform the tasks, steps, and/or methods. For example, the memory 26 may store, and the processor 24 may execute, one or more methods for configuring and/or providing a mobile web application, and/or portions or steps of one or more such methods. An exemplary embodiment of one such method is illustrated in and will be described with respect to FIG. 4.

Referring still to FIG. 2, rather than creating separate versions of pages for separate users 40₁, 40₂ and/or to update or alter the content of a page, the second system 30 is configured to dynamically determine the content of the requested page at the time of its request, to retrieve that content, and to provide a web page to the user including the content. In furtherance of this scheme, the web server 12 may be provided with a web application 32, a middleware portion 34, and a set of stored configurations 36. That is, the memory 26 of the web server 12 may store, for execution or use by the processor 26, instructions corresponding to the web application 32, middleware 34, and configurations 36.

The web application 32 may be, as noted above, Microsoft™ SharePoint™ or another application. For example, the web application 32 may include one or more pre-arranged pages. These pre-arranged pages may be SharePoint™ application pages, in an embodiment. Such application pages may be the only pages functionally available in the mobile web application, in an embodiment (i.e., the only pages stored for retrieval for the user). That is, the web application may include a discrete, static number of pages.

The data server 14 may store a plurality of content artifacts 38. Three such artifacts 38₁, 38₂, 38₃ are illustrated in FIG. 2, but it should be understood that potentially very many content artifacts may be stored in the data server 14. The artifacts 38 may include SharePoint™ “authored” artifacts, in an embodiment, or the equivalent in other applications. Content artifacts 38 stored in the data server may include, in an embodiment, compilations of documents, discussions, tasks, calendar entries, and other user-created information. Accordingly, inclusion of particular content artifacts 38 in a mobile web application for a user may grant the user access to the documents, discussions, tasks, calendar entries, and other information compiled within those particular content artifacts 38. The content artifacts 38 may also be used in a non-mobile version of the application, which may also be hosted by a web server. Thus, by virtue of the configurations 36, as will be explained below, the same content artifacts 38 already used for a non-mobile version of the web application 32 can be customized for use in a mobile application.

The configurations 36 may include a plurality of configurations (thus, configurations 36 may be referred to herein in the plural (configurations 36, referring to a set of two or more, up to the full plurality of configurations stored in the memory 26)) or singular (configuration 36, referring to a single configuration from the plurality stored in the memory 26)). Each configuration 36 may include an indication, list, etc. of a set of content artifacts 38 to be included on one of the static number of pages of the web application 32. A configuration 36 may be associated with a specific user or users, in an embodiment. Additionally or alternatively, a configuration 36 may be associated with a specific mobile device or mobile devices, in an embodiment. Additionally or alternatively, a configuration 36 may be associated with a specific security level, in an embodiment. Although illustrated as stored in the memory of the web server 12, the configurations 36 may be stored in the data server 14, in an embodiment. The configurations 36 may be applied to use data (i.e., content artifacts 38) already extant for a non-mobile version of the application and to use those content artifacts 38 in a customizable mobile version of the application. Because individual configurations 36 may be associated with specific users, mobile devices, etc., there may be a large number of unique configurations. For example, in an embodiment, there may be as many configurations 36, or more configurations 36, as there are users of the application or mobile devices intended to use the application.

The middleware 34 may comprise a set of class libraries, in an embodiment. The middleware 34 may be written in C#.NET, in an embodiment. Further, in an embodiment in which the web application is a SharePoint™ application, the middleware 34 may include class libraries utilizing the SharePoint™ Server Side Object Model to interact with the web application 32. The middleware 34 may be configured to interact with the web application 32 to provide the web application 32 with information for providing one or more web pages for a mobile device 22. For example, the middleware 34 may be configured to receive (e.g., from the web application 32) a request for one of the pages of the web application 32, the request originating at a mobile device 22. In response to the request, the middleware 34 may be configured to determine a stored configuration 36 appropriate for the mobile device 22 and/or user associated with the request (i.e., from which the request originated), to retrieve the content artifacts 38 associated with that configuration 36, and to provide those content artifacts 38 to the web application 32 to cause the content artifacts 38 to be included on the mobile web page requested.

The class libraries of the middleware 34 may be specifically configured for a specific web application (e.g., Microsoft™ SharePoint™), in an embodiment, but may be easily configurable for another web application (e.g., Microsoft Dynamics™ CRM, Microsoft Dynamics™ AX, and the like). The middleware 34 may be configurable, for example, in Microsoft™ Visual Studio™.

Once the content artifacts 38 have been selected for inclusion on the mobile web page, the middleware 34 and/or the web application 32 may define code that describes the format of the content artifacts 38 on the page. The code may be HTML code, in an embodiment. In an embodiment, defining the code may comprise dynamic creation of the code at the time of retrieval of the page, depending on which content artifacts 38 are included in the configuration 36 associated with the mobile device 22 and/or user 40 from which the page request originated. Alternatively, in an embodiment, defining the code may comprise retrieving the code along with the configuration 36 responsive to the request. Accordingly, in such an embodiment, the middleware 34 may be configured to define the code at the time that an administrator submits the configuration 36 to which the code applies.

The middleware 34 may be further configured to provide a configuration page for an administrator of the mobile web application 32. Accordingly, the administrator may add, remove, and edit configurations through the configuration page, which configurations 36 may be stored in the memory 26 of the web server 12. Thus, in contrast with the first system 10 of FIG. 1, the second system 30 may use a plurality of configurations 36 that may be customized for specific users 40 or mobile devices 22, instead of a plurality of pages that are customized for specific users 40 or mobile devices 22.

As noted above, an administrator may use the configuration page to associate specific configurations 36 with specific users 40 or mobile devices 22. Additionally or alternatively, the administrator may use the configuration page to create security levels, to associate particular users 40 or mobile devices 22 with those security levels, and to also associate particular configurations 36 with particular security levels. In such an embodiment, when selecting an appropriate configuration 36 responsive to a request for a mobile web page from a mobile device 22, the security level associated with that mobile device 22 and/or the user 40 of the mobile device 22 may be determined, and the configuration 36 selected according to that security level. As a result, content included on a page returned to a mobile device 22 may depend on the security level associated with the mobile device or user of the mobile device.

Although the addition, removal, and editing of configurations 36 is described herein as being performed by an “administrator,” this disclosure is not so limited. Rather, configuration-setting and other functions described or otherwise enabled herein with respect to non-mobile devices may be performed by any user of a non-mobile device, if deemed appropriate by the owner or proprietor of the relevant system.

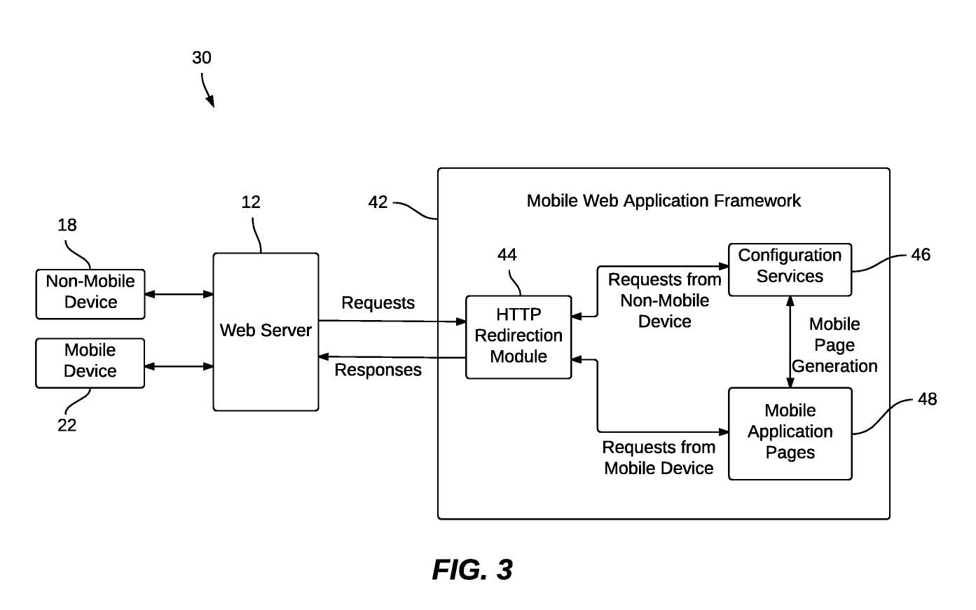

FIG. 3 is an alternate block diagram view of the second system 30, illustrating a redirection functionality that may be included in the system 30. As conceptualized in FIG. 3, the system 30 may include the web server 12 and a mobile web application framework 42. The framework 42 may be implemented in the web server 12, in an embodiment, though shown separately in FIG. 3. Referring to FIGS. 2 and 3, the framework 42 may comprise components of the middleware 34, web application 32, and/or the configurations 36, in an embodiment.

The framework 42 may include a redirection module 44, configuration services 46, and a set of mobile application pages 48, in an embodiment. The framework 42 may receive requests to access one or more of the mobile application pages 48 from one or more mobile devices 22 and one or more non-mobile devices 18. The redirection module 44 may be configured to determine whether the request originated from a mobile device 22 or a non-mobile device 18. If the request originated from a mobile device 22, the redirection module 44 may direct the request to the mobile application pages 48, for a mobile application page having the appropriate configuration for the mobile device 22 and/or user of the mobile device to be returned to the mobile device 22. If the request originated from a non-mobile device 18, the redirection module 44 may direct the request to the configuration services 46, for a configuration page for adding, removing, or editing a configuration of the requested page to be returned to the non-mobile device 18.

FIG. 4 is a flow chart illustrating an exemplary embodiment of a method 50 of configuring and providing a mobile web application. The method 50 may include a first step 52 that includes receiving a first request for a mobile web page, the first request originating at a non-mobile device. Referring to FIG. 2, the request may be first received by a web server 12, and may be further received by a web application 32 deployed on the web server 12, and may be further received by middleware 34 deployed on the web server 12 or on a data server 14 or another server or computing device.

Referring again to FIG. 4, the method 50 may further include a step 54 that includes causing, responsive to the first request, a configuration web page allowing configuration of the mobile web page to be transmitted to the non-mobile device. The configuration page may accept administrator or other user input to add, remove, and/or edit one or more configurations for one or more mobile pages. The configuration page may accept a single configuration at a time, or multiple configurations at a time, in embodiments. Each configuration may include one or more content artifacts selected from a plurality of content artifacts and may be associated with one or more users and/or one or more mobile devices.

The method 50 may further include a step that includes receiving and storing one or more configurations. The configurations may be received through the configuration page, in an embodiment, and thus may reflect the input of an administrator or other user of the configuration page. Referring to FIG. 2, the configurations 36 may be received by the middleware 34 and/or web application 32 and may be stored in the configurations portion 36 of the web server 12 and/or in the data server 14.

Referring to FIG. 4, the method 50 may further include a step 56 that includes receiving a second request for the mobile web page, the second request originating at a first mobile device 22₁. The method may further include a step 58 that includes identifying a user 40₁ associated with the first mobile device 22₁. Additionally or alternatively, the step 58 may include identifying the mobile device 22₁ from which the request originated. Additionally or alternatively, the step 58 may include identifying a security level associated with the user 40₁ and/or mobile device 22₁, in an embodiment. The identity of the user 40₁ and/or of the mobile device 22₁, and/or a security level, may be used later in the method 50 to identify a configuration 36 for the page requested to be provided responsive to the second request. Referring to FIGS. 2 and 4, the second request may be received by the web server 12, the web application 32, and/or the middleware 34, in embodiments.

With continued reference to FIGS. 2 and 4, the method 50 may further include a step 60 that includes selecting, responsive to the second request, a first set of one or more content artifacts 38 to be rendered from a plurality of content artifacts 38. The selecting step 60 may include identifying a configuration 36 associated with the user 40₁ and/or mobile device 22₁ from which the second request originated, in an embodiment, and selecting the content artifacts 38 included in that configuration 36. The selecting step 60 may further include retrieving the selected content artifacts 38 from the data server 14, in an embodiment. The selecting step 60 may be performed by the middleware 34, in an embodiment.

The method 50 may further include a step 62 that includes defining first code that describes how the first set of one or more content artifacts 38 should be formatted on the mobile web page. The first code may be or may include HTML code, in an embodiment. The code may be defined along with the configuration 36 to which it relates, in an embodiment. That is, the code may be defined as a part of the receiving and storing step. Alternatively, the code may be defined at the time that the configuration 36 and/or one or more content artifacts 38 are retrieved for inclusion on the requested mobile web page for transmission to the requesting mobile device. Accordingly, the code may be defined responsive to a set of retrieved content artifacts 38, in an embodiment.

With continued reference to FIGS. 2 and 4, the method 50 may further include a step 64 that includes causing a mobile web page comprising the first set of one or more content artifacts 38, formatted according to the first code, to be transmitted to the first mobile device 22₁. The page may be transmitted by the web server 12 to the first mobile device 22₁, in an embodiment. The middleware 34 and/or the web application 32 may cause the web server 12 to transmit the page, in an embodiment.

The method 50 may further include a step 66 that includes receiving a third request for the mobile web page, the third request originating at a second mobile device 22₃. The method 50 may further include a step 68 that includes identifying a user 40₂ associated with the second mobile device 22₃. Additionally or alternatively, the step 68 may include identifying the mobile device 22₃ from which the request originated. Additionally or alternatively, the step 68 may include identifying a security level associated with the user 40₂ and/or mobile device 22₃, in an embodiment. The identity of the user 40₂ and/or of the second mobile device 22₃, and/or a security level, may be used later in the method 50 to identify a configuration 36 for the page requested to be provided responsive to the third request. The third request may be received by the web server 12, the web application 32, and/or the middleware 34, in embodiments.

With continued reference to FIGS. 2 and 4, the method 50 may further include a step 70 that includes selecting, responsive to the third request, a second set of one or more content artifacts 38 to be rendered from a plurality of content artifacts 38. The selecting step 70 may include identifying a configuration 36 associated with the user 40₂ and/or mobile device 22₃ from which the third request originated, in an embodiment, and selecting the content artifacts 38 included in that configuration 36. The selecting step 70 may further include retrieving the selected content artifacts 38 from the data server 14, in an embodiment. The selecting step 70 may be performed by the middleware 34, in an embodiment.

The method 50 may further include a step 72 that includes defining second code that describes how the second set of one or more content artifacts 38 should be formatted on the mobile web page. The second code may be or may include HTML code, in an embodiment. The code may be defined along with the configuration 36 to which it relates, in an embodiment. That is, the code may be defined as a part of the receiving and storing step. Alternatively, the code may be defined at the time that the configuration 36 and/or one or more content artifacts 38 are retrieved for inclusion on the requested mobile web page for transmission to the requesting mobile device 22₃. Accordingly, the code may be defined responsive to a set of retrieved content artifacts 38, in an embodiment.

With continued reference to FIGS. 2 and 4, the method 50 may further include a step 74 that includes causing a mobile web page comprising the second set of one or more content artifacts 38, formatted according to the second code, to be transmitted to the second mobile device 22₃. The page may be transmitted by the web server 12 to the second mobile device 22₃, in an embodiment. The middleware 34 and/or the web application 32 may cause the web server 12 to transmit the page, in an embodiment.

Referring to FIGS. 2 and 4, the method 50 may enable the second system 30 to dynamically determine the content for a mobile web page requested from a mobile device 22 according to a configuration 36 associated with the mobile device 22 or user 40 of the mobile device 22. Accordingly, in an embodiment, the same configuration 36 may be used to return a requested page to two mobile devices associated with the same user (e.g., mobile devices 22₁, 22₂ associated with a first user 40₁ may be associated with the same first configuration 36 for a page by virtue of being associated with the same first user 40₁, and mobile devices 22₃, 22₄ associated with a second user 40₂ may be associated with the same second configuration 36 for the page by virtue of their association with the same user 40₂). Alternatively, in an embodiment, configurations 36 may be associated with specific mobile devices 22, such that first, second, third, and fourth mobile devices 22ₖ, 22₂, 22₃, 22₄ may be associated with four separate configurations for a given page.

The use of a configuration page in the system 30, rather than a plurality of separate pages for different versions and/or users, allows for the same static number of pages for a mobile web application to be customized for different users, as described above.

The method of FIG. 4 may include steps performed by a number of servers, applications, etc. to configure and provide a mobile web application. In an embodiment, certain steps in the method or another method may be implemented in middleware to provide a mobile web application, which middleware may offer improved capabilities over a web application with which the middleware interacts.

In an embodiment, referring to FIGS. 2 and 4, the middleware 34 may be provided to interact with the web application 32 to enable dynamic configuration of a static number of pages provided by the web application 32 according to the method 50. Accordingly, the middleware 34 may be stored and/or installed separately from the web application 32 and may be configured to perform specific steps in the method 50, in an embodiment. Of course, in embodiments, the middleware 34, the web application 32, and/or other applications and services may be involved in numerous steps of the method.

It should be understood that a computing system or a processor as described herein may include a conventional processing apparatus known in the art, capable of executing pre-programmed instructions stored in an associated memory, all performing in accordance with the functionality described herein. To the extent that the methods described herein are embodied in software, the resulting software can be stored in an associated memory, such as memory, and can also constitute the means for performing such methods. Such a computer system or processor may further be of the type having both ROM, RAM, a combination of non-volatile and volatile (modifiable) memory so that any software may be stored and yet allow storage and processing of dynamically produced data and/or signals.

It should be further understood that an article of manufacture in accordance with this disclosure includes a non-transitory computer-readable storage medium having a computer program encoded thereon for implementing the functionality described herein. The computer program includes code to perform one or more of the methods disclosed herein. Such embodiments may be configured to execute one or more processors, multiple processors that are integrated into a single system or are distributed over and connected together through a communications network, and where the network may be wired or wireless.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although only certain embodiments have been described above with a certain degree of particularity, those skilled in the art could make numerous alterations to the disclosed embodiments without departing from the scope of this disclosure. Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. Additionally, the terms “communicate” and “communication” are meant to be construed broadly to encompass both wired and wireless connections and communications. As used herein, the phrases “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. It is intended that all matter contained in the above description or shown in the accompanying drawings shall be interpreted as illustrative only and not limiting. Changes in detail or structure may be made without departing from the invention as defined in the appended claims.

What is claimed is:

1. A method comprising:
receiving a request for a web page, the request originating from a mobile device;
selecting, responsive to the request, one or more content artifacts to be rendered from a plurality of content artifacts;
retrieving the one or more content artifacts from a content database;
defining code that describes how the one or more content artifacts should be formatted on the mobile device; and
transmitting the one or more content artifacts and the code for the mobile device.

2. The method of claim 1, wherein the mobile device is a first mobile device, the one or more content artifacts is a first set of one or more content artifacts, and the code is first code, the method further comprising:
receiving a request for the web page, the request originating from a second mobile device that is different from the first mobile device;
selecting, responsive to the request from the second mobile device, a second set of one or more content artifacts to be rendered from the plurality of content artifacts, wherein the second set of one or more content artifacts is different from the first set of one or more content artifacts;
retrieving the second set of one or more content artifacts from the content server;
defining second code that describes how the second set of one or more content artifacts should be formatted on the second mobile device; and
transmitting the second set of one or more content artifacts and the second code for the mobile device.

3. The method of claim 2, wherein the second code describes a different format than then first code.

4. The method of claim 2, wherein the second code describes the same format as the first code.

5. The method of claim 1, wherein determining one or more content artifacts to be rendered responsive to the web page request comprises:
determining a user associated with the mobile device; and
determining one or more content artifacts associated with the user.

6. The method of claim 1, wherein determining one or more content artifacts to be rendered responsive to the web page request comprises:
determining a security clearance associated with the mobile device; and
determining one or more content artifacts associated with the security clearance.

7. The method of claim 1, wherein the code is HTML code.

8. A method comprising:
receiving a first request for a mobile web page, the first request originating at a non-mobile device;
causing, responsive to the first request, a configuration web page allowing configuration of the mobile web page to be transmitted to the non-mobile device;
receiving a second request for the mobile web page, the second request originating at a mobile device;
selecting, responsive to the second request, one or more content artifacts to be rendered from a plurality of content artifacts; and
causing a mobile web page comprising the one or more content artifacts to be transmitted to the mobile device.

9. The method of claim 8, further comprising:
receiving two or more configurations from the non-mobile device responsive to the configuration web page, each configuration comprising an indication of a respective set of one or more content artifacts to be included on the mobile web page; and
causing the configurations to be stored for retrieval when the mobile web page is requested by a mobile device.

10. The method of claim 9, wherein each configuration further comprises a respective one or more users associated with the configuration.

11. The method of claim 10, further comprising:
determining a user associated with the mobile device; and
selecting, responsive to the second request, one or more content artifacts to be rendered from a plurality of content artifacts by determining the configuration associated with the user that is associated with the mobile device.

12. The method of claim 8, wherein the mobile device is a first mobile device and the one or more content artifacts are a first set of one or more content artifacts, the method further comprising:
receiving a third request for the mobile web page, the third request originating at a second mobile device;
selecting, responsive to the third request, a second set of one or more content artifacts to be rendered from the plurality of content artifacts, wherein the second set is different from the first set; and
causing a mobile web page comprising the second set of one or more content artifacts to be transmitted to the mobile device.

13. The method of claim 8, further comprising:
defining code that describes how the one or more content artifacts should be formatted on the mobile web page; and
causing a mobile web page comprising the one or more content artifacts formatted according to the code to be transmitted to the mobile device.

14. The method of claim 13, wherein the mobile device is a first mobile device, the one or more content artifacts are a first set of one or more content artifacts, and the code is first code, the method further comprising:
receiving a third request for the mobile web page, the third request originating at a second mobile device;
selecting, responsive to the third request, a second set of one or more content artifacts to be rendered from the plurality of content artifacts, wherein the second set is different from the first set;
defining second code that described how the second set of one or more content artifacts should be formatted on the mobile web page; and
causing a mobile web page comprising the second set of one or more content artifacts formatted according to the second code to be transmitted to the mobile device.

15. The method of claim 13, wherein the code is HTML code.

16. A system comprising:
a data server storing a plurality of content artifacts;
a web application configured to provide a static number of web pages for rendering on mobile devices; and
middleware configured to:
receive a request for one of the web pages, the request originating from a mobile device;
select a stored configuration associated with a user of the mobile device, wherein the configuration is retrieved from a plurality of stored configurations respectively associated with different users, each configuration including a set of content artifacts;
retrieve content artifacts from the database according to the selected configuration; and
provide the retrieved content artifacts to the web application for transmission to the mobile device on a web page.

17. The system of claim 16, wherein the request is a first request, the mobile device is a first mobile device, and the stored configuration is a first stored configuration, wherein the middleware is further configured to:
receive a second request for the one of the web pages, the second request originating from a second mobile device;
select a second stored configuration associated with a user of the second mobile device, wherein the second stored configuration is retrieved from the plurality of stored configurations, wherein the second stored configuration includes a different set of content artifacts than the first stored configuration;
retrieve content artifacts from the database according to the selected configuration; and
provide the retrieved content artifacts to the web application for transmission to the mobile device on a web page.

18. The system of claim 16, further comprising a web server, wherein the middleware is deployed on the web server.

19. The system of claim 18, wherein the web server is configured to detect whether a request for one of the web pages originates from a mobile device or a non-mobile device.

20. The system of claim 19, wherein the middleware is further configured to provide a configuration page for a non-mobile device, the configuration page for receiving input for defining one or more configurations of one or more of the mobile web pages.
